(19) United States
(12) Patent Application Publication
(10) Pub. No.: US 2025/0123731 A1
(43) Pub. Date: Apr. 17, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Natsuko KATO, Kanagawa (JP)

(73) Assignee: FUJIFILM Business Innovation Corp., Tokyo (JP)

(21) Appl. No.: 18/637,430

(22) Filed: Apr. 16, 2024

(30) Foreign Application Priority Data
Oct. 11, 2023 (JP) 2023-175761

(51) Int. Cl. G06F 3/04845; G06F 3/04817

(52) U.S. Cl. CPC G06F 3/04845; G06F 3/04817

(57) ABSTRACT

An information processing system includes one or more processors configured to receive a classification operation for classifying a plurality of items generated in advance into a displayed item to be displayed on a selection screen and a hidden item not to be displayed, display on the selection screen, the item classified as the displayed item and a button for causing the hidden item to be displayed, and display the hidden item on the selection screen when the button is operated.

### CROSS-REFERENCE TO RELATED APPLICATIONS

This application is based on and claims priority under 35 USC 119 from Japanese Patent Application No. 2023-175761 filed Oct. 11, 2023.

### BACKGROUND

### (i) Technical Field

The present disclosure relates to an information processing system and a non-transitory computer readable medium.

### (ii) Related Art

There has been known a technique for supporting a selection operation for an item frequently used by a user, through changing of a display order of items displayed on a screen or reception of designation of a display position of the item (for example, Japanese Unexamined Patent Application Publication No. 8-317305). With such a technique, among items generated as items that can be targets of the selection operation by a user, only a predetermined number of items are displayed, and the other items are hidden.

### SUMMARY

When only a predetermined number of items among the items generated as the items that can be targets of the selection operation by the user are displayed and the other items are hidden, the user may end up feeling difficulty in the selection operation.

Aspects of non-limiting embodiments of the present disclosure relate to making a selection operation for an item by a user easier than that in a case of hiding items other than a predetermined number of items among items that can be targets of the selection operation by the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or more processors configured to receive a classification operation for classifying a plurality of items generated in advance into a displayed item to be displayed on a selection screen and a hidden item not to be displayed, display, on the selection screen, the item classified as the displayed item and a button for causing the hidden item to be displayed, and display the hidden item on the selection screen when the button is operated.

### BRIEF DESCRIPTION OF THE DRAWINGS

Exemplary embodiments of the present disclosure will be described in detail based on the following figures, wherein:

FIG. 1 is a diagram illustrating an example of an overall configuration of an information processing system to which the present exemplary embodiment is applied;

FIG. 2 is a diagram illustrating an example of a hardware configuration of a management server;

FIG. 3 is a diagram illustrating an example of a functional configuration of a control unit of the management server;

FIG. 4 is a diagram illustrating an example of a functional configuration of a control unit of a client terminal;

FIG. 5 is a flowchart illustrating a flow of processing of the management server;

FIG. 6 is a flowchart illustrating a flow of processing of the client terminal;

FIG. 7 is a diagram illustrating a specific example of a setting screen displayed on a user interface of the client terminal;

FIGS. 8A and 8B are diagrams illustrating a specific example of a selection screen displayed on the user interface of the client terminal;

FIG. 9 is a diagram illustrating a specific example of an order setting operation;

FIGS. 10A and 10B are diagrams illustrating specific examples of the selection screen generated after the order setting operation and a classification operation are performed on the setting screen;

FIG. 11 is a diagram illustrating another specific example of the setting screen displayed on the user interface of the client terminal; and

FIGS. 12A and 12B are diagrams illustrating a specific example of the selection screen generated after the order setting operation and the classification operation are performed on the setting screen.

### DETAILED DESCRIPTION

Exemplary embodiments of the present disclosure will be described below in detail with reference to the accompanying drawings.

### <System Configuration>

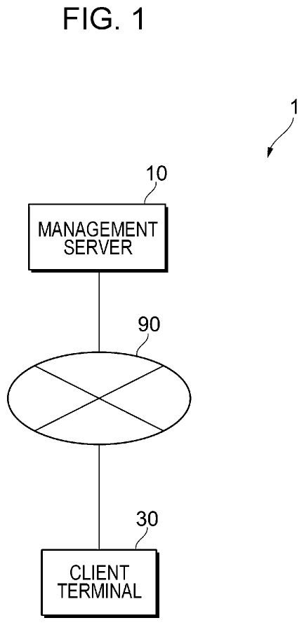

FIG. 1 is a diagram illustrating an example of an overall configuration of an information processing system 1 to which the present exemplary embodiment is applied.

The information processing system 1 includes a management server 10 and a client terminal 30 that are connected to each other via a network 90. The network 90 is, for example, a local area network (LAN), the Internet, or the like.

### (Management Server)

The management server 10 is an information processing apparatus serving as a server that manages the entire information processing system 1. Processing of the management server 10 acquires various types of information transmitted from the client terminal 30 and enables execution of various types of processing. The processing of the management server 10 transmits various types of information to the client terminal 30 and enables the client terminal 30 to execute various types of processing.

The processing of the management server 10 acquires, as classification information, information input through an operation (hereinafter, referred to as “classification operation”) of classifying a plurality of predetermined items generated in advance into an item (hereinafter, referred to as “displayed item”) to be displayed on a selection screen and an item (hereinafter, referred to as “hidden item”) not to be displayed. The “item” is a button or the like to be a target of an operation by the user, in a user interface displayed on a screen of the client terminal 30. The “selection screen” is an operation area, such as a so-called menu screen, to be a target of an operation by the user in the user interface. The classification operation is performed by a user who operates the client terminal 30.

The processing of the management server 10 displays an item classified as the displayed item and a button (hereinafter, referred to as “open button”) for displaying the hidden item on a selection screen. Then, in response to an operation on the open button, the hidden item is displayed on the selection screen. The “operation on the open button” is, for example, an operation of pressing the open button (such as a clicking operation or a tapping operation). Specifically, when the open button is operated, the processing of the management server 10 displays, on the selection screen of the user interface displayed on the client terminal 30, an operation area (hereinafter, referred to as “accordion menu”) including one or more hidden items. When the open button is operated again in a state where the accordion menu is displayed, the processing of the management server 10 hides the accordion menu from the selection screen of the user interface displayed on the client terminal 30.

The processing of the management server 10 acquires as display setting information, information input through an operation (hereinafter, referred to as “display setting operation”) for displaying or hiding the open button on the selection screen. The processing of the management server 10 acquires as order setting information, information input through an operation (hereinafter, referred to as “order setting operation”) for setting the display order of each of the displayed and the hidden items displayed on the selection screen.

The processing of the management server 10 displays a screen (hereinafter, referred to as “setting screen”) on which the classification operation and the order setting operation can be received, on the user interface. The selection screen is provided with a button for causing the setting screen to be displayed (hereinafter, referred to as “setting screen display button”). When the setting screen display button is pressed, the setting screen is displayed on the user interface.

The processing of the management server 10 performs control for limiting a person who performs each of the classification operation, the display setting operation, and the order setting operation to a user or an administrator having a predetermined authority. The processing of the management server 10 performs control for limiting a person who can access the setting screen to a user or an administrator having a predetermined authority. As such control, for example, the processing of the management server 10 may manage an ID of each of the user and the administrator who operate the client terminal 30, and may manage information indicating whether the user or the administrator has a predetermined authority in association with the ID. The configuration and the processing of the management server 10 will be described in detail later.

### (Client Terminal)

The client terminal 30 is an information processing apparatus, such as an image processing apparatus, a personal computer, a tablet terminal, or a smartphone, operated by a user who uses the information processing system 1.

The client terminal 30 acquires various types of information transmitted from the management server 10 and executes various types of processing. The client terminal 30 transmits various types of information to the management server 10. For example, the client terminal 30 displays the user interface including the selection screen, the setting screen, and the like.

The client terminal 30 receives the classification operation and transmits the content of the operation to the management server 10 as the classification information. The client terminal 30 receives the display setting operation and transmits the content of the operation to the management server 10 as the display setting information. The client terminal 30 receives the order setting operation and transmits the content of the operation to the management server 10 as the order setting information. The client terminal 30 receives a button display setting operation and transmits the content of the operation to the management server 10 as button display setting information.

The client terminal 30 acquires control information for displaying the user interface including the selection screen, the setting screen, and the like, transmitted from the management server 10, and displays the user interface on the screen of the client terminal 30 based on the control information. The configuration and processing of the client terminal 30 will be described later in detail.

The configuration of the information processing system 1 described above is an example, and it suffices if the information processing system 1 as a whole has functions of implementing the processing described above. Thus, some or all of the functions for implementing the above-described processing may be shared or may cooperate with each other in the information processing system 1. That is, some or all of the functions of the management server 10 may be implemented as functions of the client terminal 30, and some or all of the functions of the client terminal 30 may be implemented as functions of the management server 10. Some or all of the functions of the client terminal 30 and the management server 10, which configurate the information processing system 1, may be transferred to another server or the like (not illustrated). Thus, the processing of the information processing system 1 as a whole is facilitated, and the processing can be executed in a complementary manner.

### <Hardware Configuration>

### (Hardware Configuration of Management Server)

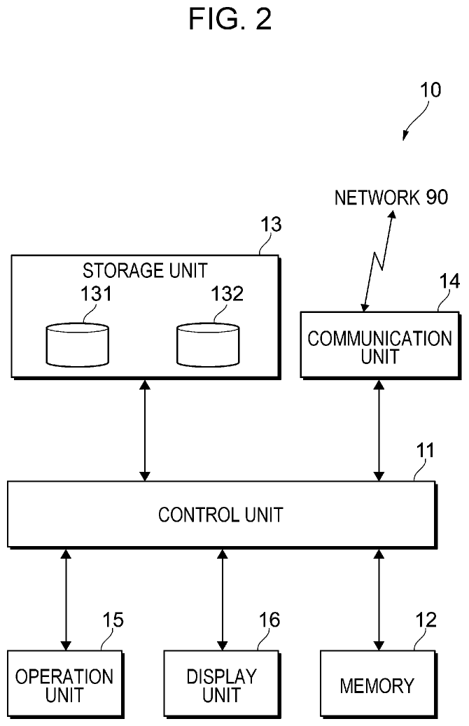

FIG. 2 is a diagram illustrating an example of a hardware configuration of the management server 10.

The management server 10 includes a control unit 11, a memory 12, a storage unit 13, a communication unit 14, an operation unit 15, and a display unit 16. These units are connected to each other by a data bus, an address bus, a peripheral component interconnect (PCI) bus, or the like.

The control unit 11 is a processor that controls the functions of the management server 10 through execution of various types of software such as an OS (basic software) and application software (applied software). The control unit 11 includes, for example, a central processing unit (CPU). The memory 12 is a storage area for storing various types of software, data used for executing the software, and the like, and is used as a work area for calculation. The memory 12 includes, for example, a random access memory (RAM) and the like.

The storage unit 13 is a storage area that stores input data to various types of software, output data from various types of software, and the like. The storage unit 13 includes, for example, a hard disk drive (HDD), a solid state drive (SSD), a semiconductor memory, or the like that is used to store programs, various types of setting data, and the like. The storage unit 13 is provided with, as a database for storing various types of information, for example, a classification DB 131 in which the classification information is stored, a setting DB 132 in which various types of setting information (such as the classification information, the display setting information, the order setting information, and the button display setting information) are stored, and the like.

The communication unit 14 transmits and receives data to and from the client terminal 30 and the outside through the network 90. The operation unit 15 includes, for example, a software keyboard, a mechanical button, a switch, or the like, and receives an input operation. The operation unit 15 includes a touch sensor that configurate a touch panel integrally with the display unit 16. The display unit 16 includes a liquid crystal display, an organic electro luminescence (EL) display, or the like used for displaying information, and displays data of images and texts, and the like on a screen. For example, the display unit 16 displays icons including images and texts in a display area.

### (Hardware Configuration of Client Terminal)

The hardware configuration of the client terminal 30 is the same as that of the management server 10 illustrated in FIG. 2. Thus, the client terminal 30 includes a control unit, a memory, a storage unit, a communication unit, an operation unit, and a display unit respectively having the same functions as the control unit 11, the memory 12, the storage unit 13, the communication unit 14, the operation unit 15, and the display unit 16 in FIG. 2. Therefore, illustration and description of the hardware configuration of the client terminal 30 will be omitted.

### <Functional Configuration>

### (Functional Configuration of Control Unit of Management Server)

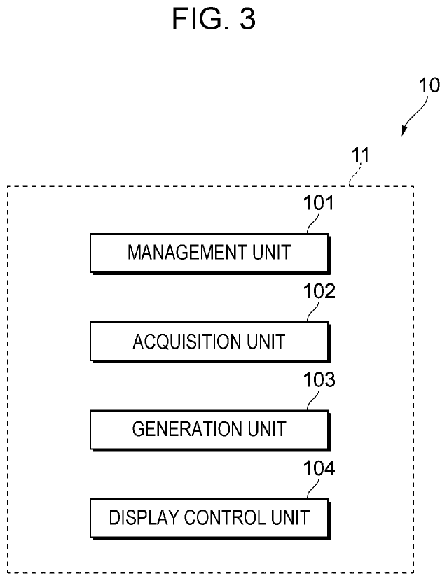

FIG. 3 is a diagram illustrating an example of a functional configuration of the control unit 11 of the management server 10.

A management unit 101, an acquisition unit 102, a generation unit 103, and a display control unit 104 function in the control unit 11 of the management server 10.

The management unit 101 stores and manages various types of information in a database of the storage unit 13 (see FIG. 2). For example, the management unit 101 stores and manages classification information for each user or each client terminal 30 in the classification DB 131. The management unit 101 stores and manages various types of setting information including the classification information, the display setting information, the order setting information, the button display setting information, and the like in the setting DB 132.

The acquisition unit 102 acquires various types of information. For example, the acquisition unit 102 acquires various types of information transmitted from the client terminal 30. Examples of the information transmitted from the client terminal 30 include the classification information, the display setting information, the order setting information, the button display setting information, and the like.

The generation unit 103 generates various screens included in the user interface displayed on the display unit of the client terminal 30. For example, the generation unit 103 generates the selection screen or the setting screen included in the user interface. The generation of the selection screen by the generation unit 103 includes, in addition to the generation of the elements such as the items, the open button, the accordion menu, and the setting screen display button to be displayed on the selection screen, the determination of the arrangement position of each element, the determination of the order of arrangement, and the like.

The display control unit 104 performs control for displaying the user interface on the display unit of the client terminal 30. Specifically, the display control unit 104 generates control information for displaying the user interface on the display unit of the client terminal 30, and transmits the control information to the client terminal 30 via the communication unit 14 (see FIG. 2).

The control information for displaying the user interface includes control information for displaying the selection screen and the setting screen included in the user interface. Furthermore, examples of the control information for displaying the selection screen include control information for displaying the open button on the selection screen, control information for displaying the accordion menu on the selection screen, control information for displaying the setting screen display button on the selection screen, and the like.

### (Functional Configuration of Control Unit of Client Terminal)

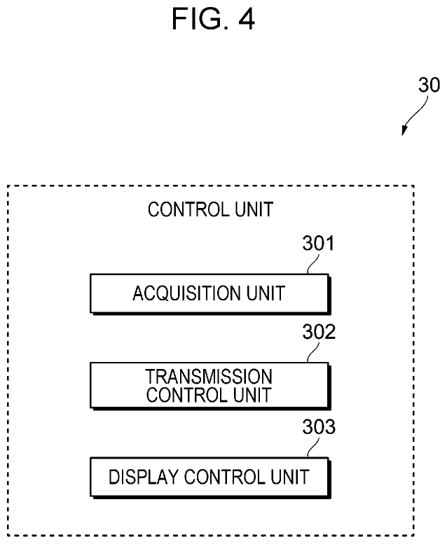

FIG. 4 is a diagram illustrating an example of a functional configuration of the control unit of the client terminal 30.

An acquisition unit 301, a transmission control unit 302, and a display control unit 303 function in the control unit of the client terminal 30.

The acquisition unit 301 acquires various types of information. For example, the acquisition unit 301 acquires various types of information transmitted from the management server 10. Examples of the information transmitted from the management server 10 include control information for causing the client terminal 30 to execute various types of processing, and the like. Examples of such control information include control information for displaying the user interface on the screen of the client terminal 30. As described above, the control information for displaying the user interface includes the control information for displaying the selection screen and the setting screen, and the control information for displaying the selection screen includes the control information for displaying the open button on the selection screen, the control information for displaying the accordion menu on the selection screen, the control information for displaying the setting screen display button on the selection screen, and the like.

The acquisition unit 301 also acquires input information on the operation received on the operation unit. Examples of such input information include information input for executing the classification operation, information input for executing the display setting operation, information input for executing the order setting operation, information input for executing the button display setting operation, and the like.

The transmission control unit 302 performs control for transmitting various types of information via the communication unit. For example, the transmission control unit 302 performs control for transmitting various types of information to the management server 10. Examples of the information to be transmitted to the management server 10 include the classification information, the display setting information, the order setting information, the button display setting information, and the like.

The display control unit 303 performs control for displaying various types of information on the display unit. For example, the display control unit 303 performs control for displaying the user interface on the display unit. Specifically, the display control unit 303 causes the display unit to display the user interface based on the control information acquired by the acquisition unit 301.

### <Flow of Processing of Management Server>

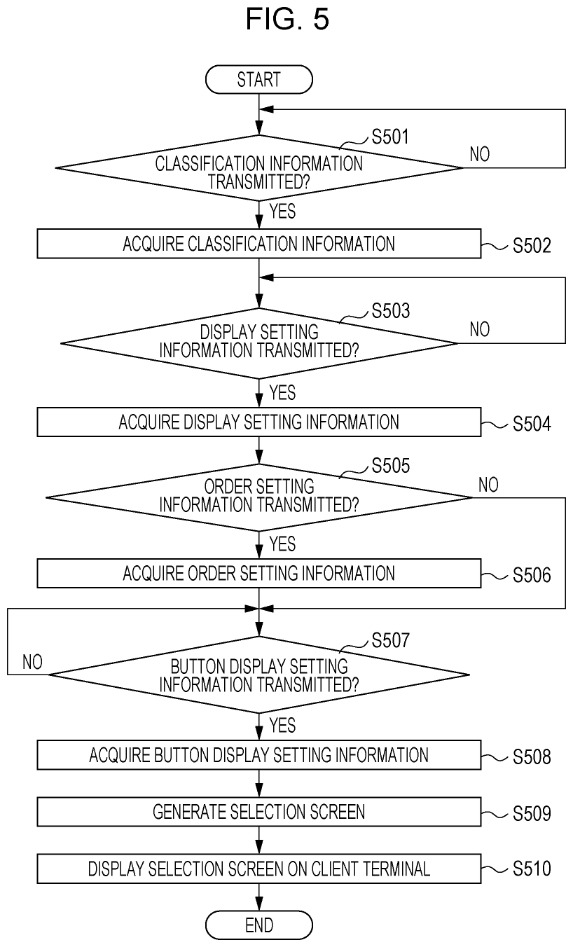

FIG. 5 is a flowchart illustrating a flow of the processing of the management server 10.

When the classification information is transmitted from the client terminal 30 (YES in step 501), the processing of the management server 10 acquires the classification information (step 502), and proceeds to determination processing in step 503. On the other hand, when the classification information is not transmitted (NO in step 501), the processing of the management server 10 repeats the determination processing in step 501 until the classification information is transmitted.

When the display setting information is transmitted from the client terminal 30 (YES in step 503), the processing of the management server 10 acquires the display setting information (step 504), and proceeds to determination processing in step 505. On the other hand, when the display setting information is not transmitted (NO in step 503), the processing of the management server 10 repeats the determination processing in step 503 until the display setting information is transmitted.

When the order setting information is transmitted from the client terminal 30 (YES in step 505), the processing of the management server 10 acquires the order setting information (step 506), and proceeds to determination processing in step 507. On the other hand, when the order setting information is not transmitted (NO in step 505), the processing of the management server 10 proceeds to the determination processing in step 507.

When the button display setting information is transmitted from the client terminal 30 (YES in step 507), the processing of the management server 10 acquires the button display setting information (step 508). Next, the processing of the management server 10 generates the selection screen (step 509), causes the client terminal 30 to display the generated selection screen (step 510), and ends the processing (END). On the other hand, when the button display setting information is not transmitted (NO in step 507), the processing of the management server 10 repeats the determination processing in step 507 until the button display setting information is transmitted.

### <Flow of Processing of Client Terminal>

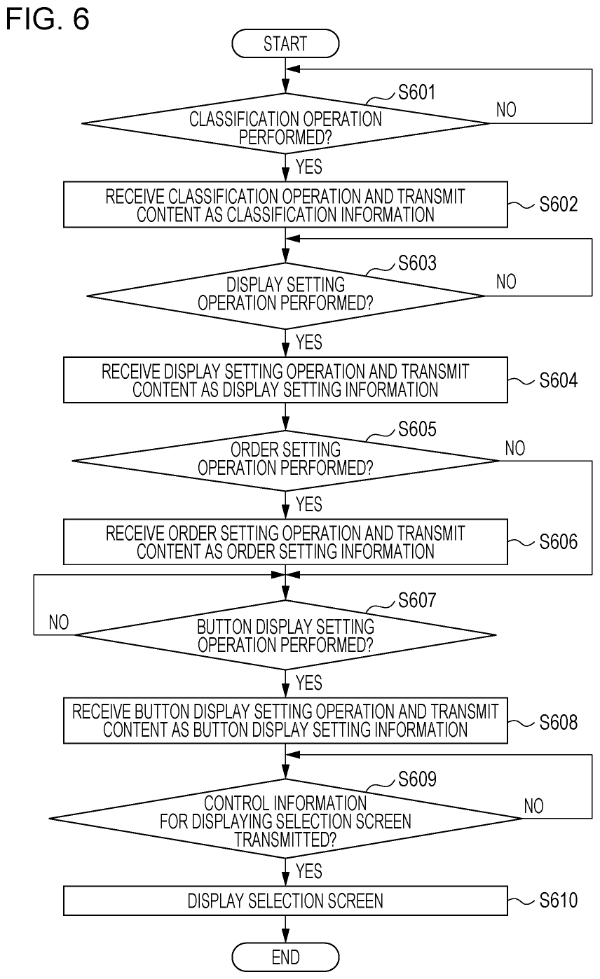

FIG. 6 is a flowchart illustrating a flow of processing of the client terminal 30.

When the classification operation is performed by the user (YES in step 601), the client terminal 30 receives the classification operation, transmits the content of the classification operation as the classification information (step 602), and proceeds to determination processing in step 603. On the other hand, when the classification operation is not performed (NO in step 601), the client terminal 30 repeats the determination processing in step 601 until the classification operation is performed.

When the display setting operation is performed by the user (YES in step 603), the client terminal 30 receives the display setting operation, transmits the content of the display setting operation as the display setting information (step 604), and proceeds to determination processing in step 605. On the other hand, when the display setting operation is not performed (NO in step 603), the client terminal 30 repeats the determination processing in step 603 until the display setting operation is performed.

When the order setting operation is performed by the user (YES in step 605), the client terminal 30 receives the order setting operation, transmits the content of the order setting operation as the order setting information (step 606), and proceeds to determination processing in step 607. On the other hand, when the order setting operation is not performed (NO in step 605), the processing of the client terminal 30 proceeds to the determination processing in step 607.

When the button display setting operation is performed by the user (YES in step 607), the client terminal 30 receives the button display setting operation, transmits the content of the button display setting operation as the button display setting information (step 608), and proceeds to determination processing in step 609. On the other hand, when the button display setting operation is not performed (NO in step 607), the client terminal 30 repeats the determination processing in step 607 until the button display setting operation is performed.

When the control information for displaying the selection screen is transmitted (YES in step 609), the client terminal 30 displays the selection screen based on the control information (step 610), and ends the processing (END). On the other hand, when the control information for displaying the selection screen is not transmitted (NO in step 609), the client terminal 30 repeats the determination processing in step 609 until the control information for displaying the selection screen is transmitted.

### Specific Examples

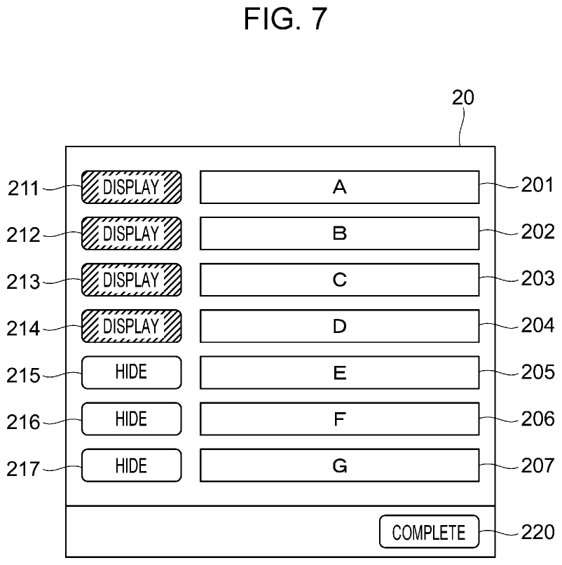

FIG. 7 is a diagram illustrating a specific example of a setting screen 20 displayed on the user interface of the client terminal 30.

On the setting screen 20 illustrated in FIG. 7, an item 201 labeled “A”, an item 202 labeled “B”, an item 203 labeled “C”, an item 204 labeled “D”, an item 205 labeled “E”, an item 206 labeled “F”, and an item 207 labeled “G” are displayed in this order from top to bottom.

On the left side of each of the items 201 to 207, classification buttons 211 to 217 for receiving the display setting operation for the respective items 201 to 207 are displayed. Thus, when each of the classification buttons 211 to 217 is pressed, corresponding one of the items 201 to 207 is classified as and set to be the displayed item or the hidden item.

The labels of the classification buttons 211 to 217 change every time the buttons are pressed. Specifically, the label is switched between “display” and “hide” every time the button is pressed. A state with the label “display” indicates that an item located on the right side is classified as the displayed item, and a state with the label “hide” indicates that an item located on the right side is classified as the hidden item. The user presses each of the classification buttons 211 to 217 to classify the respective items 201 to 207 located on the right side of the classification buttons 211 to 217 as the displayed or the hidden items.

For example, in the example illustrated in FIG. 7, the classification buttons 211 to 214 are all labeled “display”. Therefore, all of the items 201 to 204 located on the right side of the respective classification buttons 211 to 214 are classified as the displayed items. On the other hand, the classification buttons 215 to 217 are all labeled “hide”. Therefore, the items 205 to 207 located to the right side of the respective classification buttons 215 to 217 are all classified as the hidden items.

Here, for example, it is assumed that the user wants to classify the item 201, currently classified as the displayed item, as the hidden item. In this case, the user presses the classification button 211 located on the left side of the item 201 once. Then, the label of the classification button 211 changes from “display” to “hide”, and the item 201 that has been classified as the displayed item is classified as the hidden item. That is, when a classification operation of pressing the classification button 211 labeled “display” once is performed, the operation content is accepted as classification information “classify item 201 as hidden item”.

Furthermore, for example, it is assumed that the user wants to classify the item 205, currently classified as the hidden item, as the displayed item. In this case, the user presses the classification button 215 located on the left side of the item 205 once. Then, the label of the classification button 215 changes from “hide” to “display”, and the item 205 that has been classified as the hidden item is classified as the displayed item. That is, when a classification operation of pressing the classification button 215 labeled “hide” once is performed, the operation content is accepted as classification information “classify item 205 as displayed item”.

It is preferable that the label of the classification button enables the user to easily identify whether the corresponding item is classified as the displayed item or the hidden item. For example, as in the example in FIG. 7, the label “display” and the label “hide” may be distinguished from each other by patterns or the like.

When the user performs an operation of pressing each of the classification buttons 211 to 217 and finally presses a button 220 labeled “complete”, the classification operation is completed. Then, the operation content is transmitted from the client terminal 30 to the management server 10 as the classification information. Thereafter, the selection screen is generated by the processing of the management server 10.

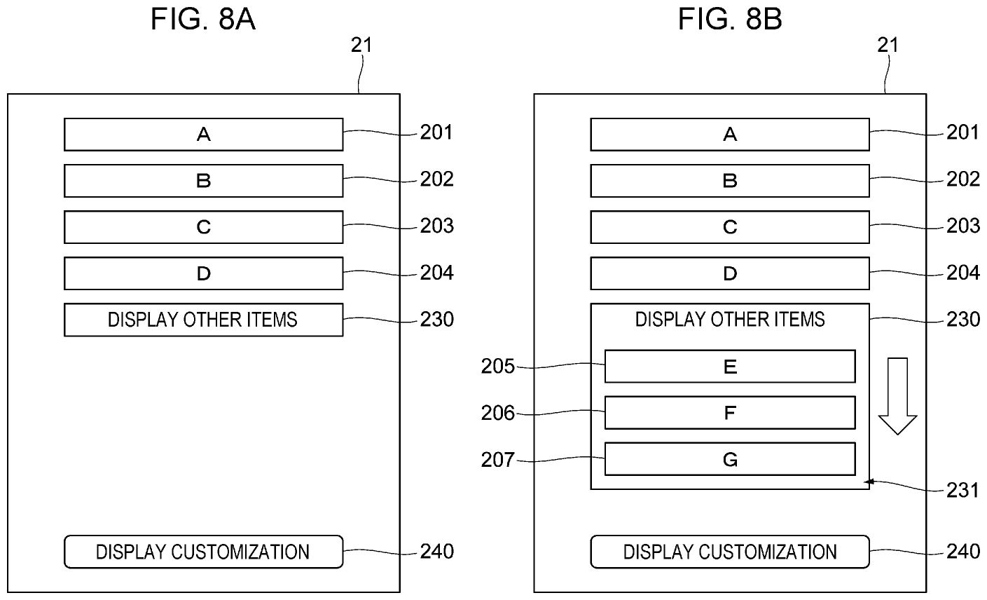

FIGS. 8A and 8B are diagrams illustrating specific examples of a selection screen 21 displayed on the user interface of the client terminal 30. Note that the selection screen 21 illustrated in FIGS. 8A and 8B is generated based on the content of the setting screen 20 in FIG. 7 described above.

The selection screen 21 illustrated in FIG. 8A includes an item 201 labeled “A”, an item 202 labeled “B”, an item 203 labeled “C”, an item 204 labeled “D”, an open button 230 labeled “display other items”, and a button 240 labeled “display customization” (hereinafter referred to as “customize button 240”) displayed in this order from top to bottom.

The items 201 to 204 displayed on the selection screen 21 are four items classified as the displayed items on the setting screen 20 (see FIG. 7). Note that the items 205 to 207 classified as the hidden items on the setting screen 20 are items that are not displayed on the selection screen 21 illustrated in FIG. 8A. Here, it is assumed that the user wants to display the items 205 to 207 classified as the hidden items on the selection screen 21. In this case, as the display setting operation, the user presses the open button 230 labeled “display other items”.

When the open button 230 is pressed, for example, as illustrated in FIG. 8B, the open button 230 of the selection screen 21 extends downward (in the direction of the arrow), and an accordion menu 231 is displayed. In the accordion menu 231, the items 205 to 207 classified as the hidden items on the setting screen 20 are displayed in this order from top to bottom.

When the customize button 240 is pressed, the setting screen 20 (see FIG. 7) is displayed again. Note that in the example of the selection screen 21 in FIG. 8A, a wide space for displaying the accordion menu 231 is formed between the open button 230 and the customize button 240, but this should not be construed in a limiting sense. For example, although not elaborated in the figures, the interval between the open button 230 and the customize button 240 may be set to be equal or substantially equal to the interval between the items, and the vertical position of the customize button 240 and the vertical length of the selection screen 21 may be changed in accordance with the expansion or contraction of the open button 230 in the vertical direction.

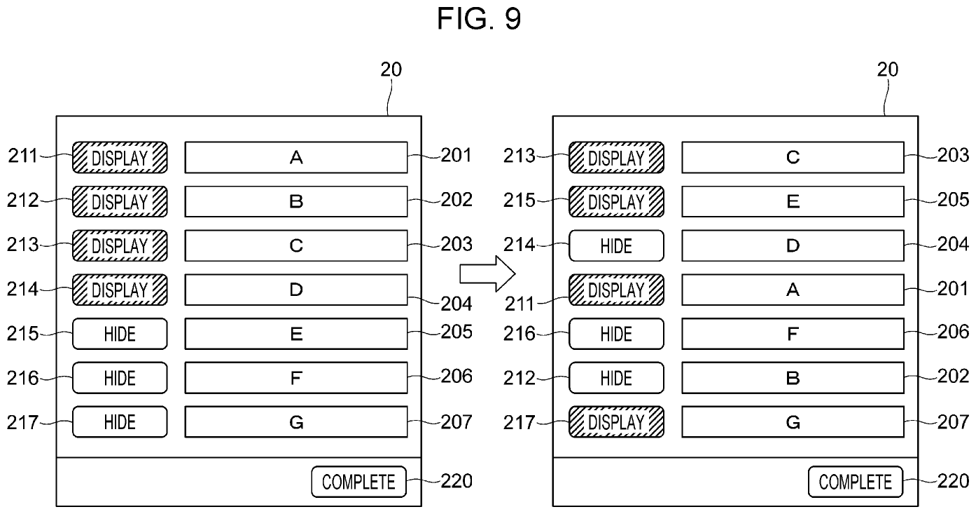

FIG. 9 is a view illustrating a specific example of the order setting operation. The left diagram of FIG. 9 illustrates a state of the setting screen 20 before the order setting operation is performed. The right diagram of FIG. 9 illustrates a state of the setting screen 20 after the order setting operation is performed.

The left diagram of FIG. 9 illustrates the setting screen 20 on which the item 201 labeled “A”, the item 202 labeled “B”, the item 203 labeled “C”, the item 204 labeled “D”, the item 205 labeled “E”, the item 206 labeled “F”, and the item 207 labeled “G” are displayed in this order from top to bottom. In the left diagram of FIG. 9, the classification buttons 211 to 217 for receiving the display setting operation for the respective items 201 to 207 are displayed on the left side of the items 201 to 207.

Here, it is assumed that the user performs the order setting operation and the classification operation on the items 201 to 207 on the setting screen 20 illustrated in the left drawing of FIG. 9. Specifically, it is assumed that, as the order setting operation, an operation of rearrangement is performed for displaying the item 203 labeled “C”, the item 205 labeled “E”, the item 204 labeled “D”, the item 201 labeled “A”, the item 206 labeled “F”, the item 202 labeled “B”, and the item 207 labeled “G” in this order from top to bottom. The order setting operation is performed by, for example, changing the vertical order through dragging and dropping a set of an item and a classification button displayed on the setting screen 20, and the like.

It is also assumed that an operation of classifying the items 201, 203, 205, and 207 as the displayed items and classifying the items 202, 204, and 206 as the hidden items is performed as the classification operation. As described above, the classification operation is performed by an operation of pressing each of the classification buttons 211 to 217.

When the user presses the button 220 labeled “complete” after performing the order setting operation and the classification operation, the order setting operation and the classification operation are completed. Then, the operation contents of each of the order setting operation and the classification operation are transmitted from the client terminal 30 to the management server 10 respectively as the order setting information and the classification information. Thereafter, the selection screen is generated by the processing of the management server 10.

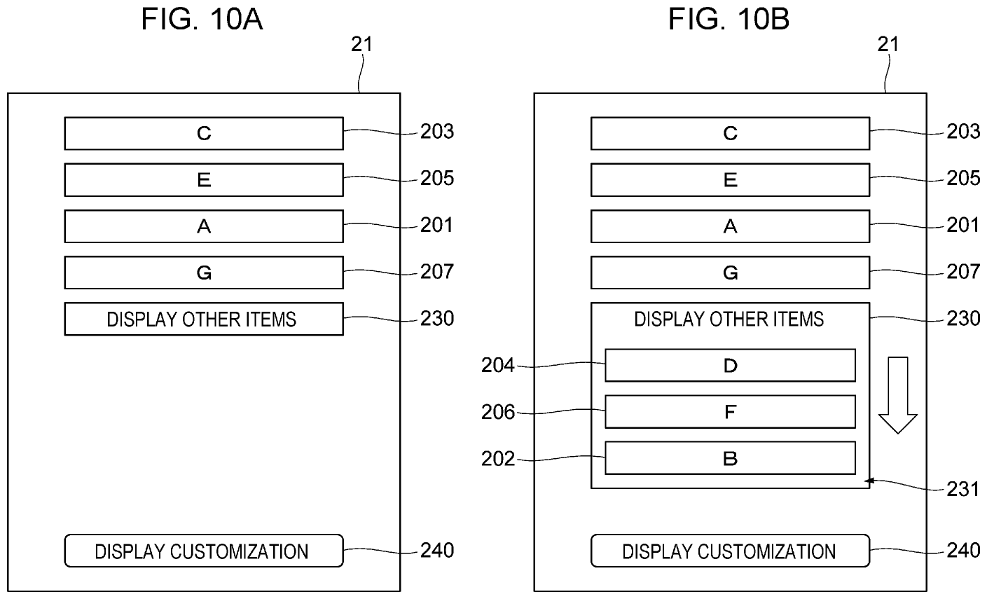

FIGS. 10A and 10B are diagrams illustrating a specific example of the selection screen 21 generated after the order setting operation and the classification operation are performed on the setting screen 20. Note that the selection screen 21 illustrated in FIGS. 10A and 10B is generated based on the content of the setting screen 20 in FIG. 9 described above.

The selection screen 21 illustrated in FIG. 10A includes the item 203 labeled “C”, the item 205 labeled “E”, the item 201 labeled “A”, the item 207 labeled “G”, the open button 230 labeled “display other items”, and the customize button 240 labeled “display customization” displayed in this order from top to bottom.

The items 203, 205, 201, and 207 displayed on the selection screen 21 are four items classified as the displayed items on the setting screen 20 (see FIG. 9). Note that the items 204, 206, and 202 classified as the hidden items on the setting screen 20 are not displayed on the selection screen 21 illustrated in FIG. 10A. Here, it is assumed that the user wants to display the items 204, 206, and 202 classified as the hidden items on the selection screen 21. In this case, as the display setting operation, the user presses the open button 230 labeled “display other items”.

When the open button 230 is pressed, for example, as illustrated in FIG. 10B, the open button 230 of the selection screen 21 extends downward (in the direction of the arrow), and the accordion menu 231 is displayed. In the accordion menu 231, the items 204, 206, and 202 classified as the hidden items on the setting screen 20 are displayed in this order from top to bottom. When the customize button 240 labeled “display customization” is pressed, the setting screen 20 (see the right drawing of FIG. 9) is displayed again.

### Modification

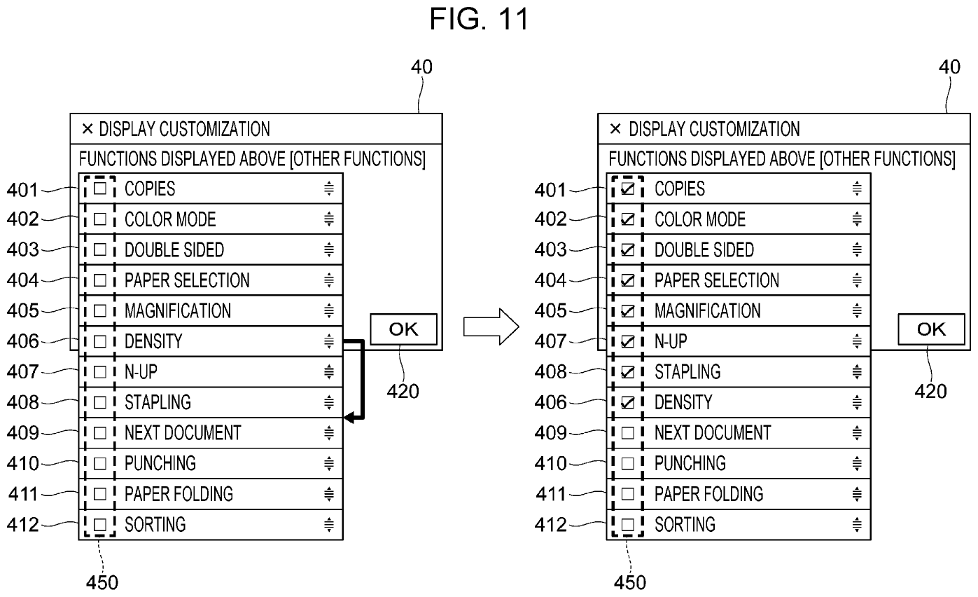

FIG. 11 is a diagram illustrating another specific example of the setting screen displayed on the user interface of the client terminal 30. Note that in the example of FIG. 11, “item” is treated as “function”.

The left diagram of FIG. 11 illustrates a setting screen 40 in which a function 401 as an item labeled “copies”, a function 402 as an item labeled “color mode”, a function 403 as an item labeled “double sided”, a function 404 as an item labeled “paper selection”, a function 405 as an item labeled “magnification”, a function 406 as an item labeled “density”, a function 407 as an item labeled “N-up”, a function 408 as an item labeled “stapling”, a function 409 as an item labeled “next document”, a function 410 as an item labeled “punching”, a function 411 as an item labeled “paper folding”, and a function 412 as an item labeled “sorting” are displayed in this order from top to bottom. In the left diagram of FIG. 11, check boxes 450 for receiving a display setting operation for the respective functions 401 to 412 are displayed at the left end of the respective functions 401 to 412.

Here, it is assumed that the user performs the order setting operation and the classification operation on the functions 401 to 412 on the setting screen 40 illustrated in the left drawing of FIG. 11. Specifically, it is assumed that, as the order setting operation, an operation of inserting the function 406 labeled “density” between the function 408 labeled “stapling” and the function 409 labeled “next document” is performed. The order setting operation is performed, for example, by dragging and dropping a function displayed on the setting screen 40 to change the vertical order of the functions, and the like.

Further, it is assumed that an operation of classifying the functions 401 to 408 as the displayed items and classifying the functions 409 to 412 as the hidden items is performed as the classification operation. The classification operation is performed by an operation of checking each of the check boxes 450. That is, the check box 450 is checked when the corresponding item is classified as a displayed item, and the check box 450 is not checked (or is unchecked) when the item is classified as a hidden item.

When the user presses a button 420 labeled “OK” after performing the order setting operation and the classification operation, the order setting operation and the classification operation are completed. Then, the operation contents of each of the order setting operation and the classification operation are transmitted from the client terminal 30 to the management server 10 respectively as the order setting information and the classification information. Thereafter, the selection screen is generated by the processing of the management server 10.

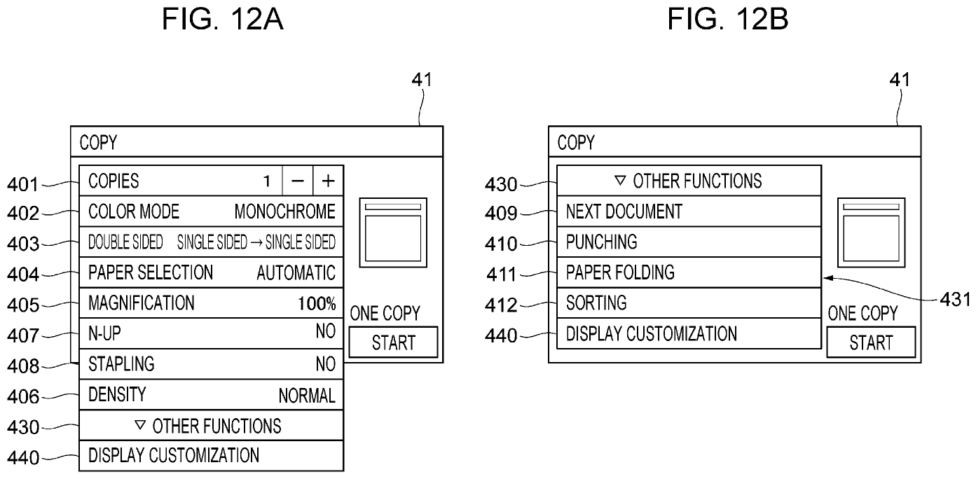

FIGS. 12A and 12B are diagrams illustrating a specific example of the selection screen generated after the order setting operation and the classification operation are performed on the setting screen. Note that a selection screen 41 illustrated in FIGS. 12A and 12B is generated based on the content of the setting screen 40 in FIG. 11 described above.

The selection screen 41 illustrated in FIG. 12A displays the function 401 as an item labeled “copies”, the function 402 as an item labeled “color mode”, the function 403 as an item labeled “double sided”, the function 404 as an item labeled “paper selection”, the function 405 as an item labeled “magnification”, the function 407 as an item labeled “N-up”, the function 408 as an item labeled “stapling”, the function 406 as an item labeled “density”, an open button 430 labeled “other functions”, and a button 440 (hereinafter, referred to as “customize button 440”) labeled “display customization” in this order from top to bottom.

The functions 401 to 408 displayed on the selection screen 41 are the eight functions classified as the displayed items on the setting screen 40 (see FIG. 11). Note that the functions 409 to 412 classified as the hidden items on the setting screen 40 are functions that are not displayed on the selection screen 41 illustrated in FIG. 12A. Here, it is assumed that the user wants to display the functions 409 to 412 classified as the hidden items on the selection screen 41. In this case, the user presses the open button 430 labeled “other functions” as the display setting operation.

When the open button 430 is pressed, for example, as illustrated in FIG. 12B, the open button 430 of the selection screen 41 extends downward, and an accordion menu 431 is displayed. In the accordion menu 431, the functions 409 to 412 classified as the hidden items on the setting screen 40 are displayed in this order from top to bottom. When the customize button 440 labeled “display customization” is pressed, the setting screen 40 (see the right drawing of FIG. 11) is displayed again.

### Other Exemplary Embodiments

While the present exemplary embodiment is described above, the present disclosure is not limited to the above-described exemplary embodiment. Furthermore, the advantageous effects of the present disclosure are also not limited to those described in the above-described exemplary embodiment. For example, any of the configuration of the information processing system 1 illustrated in FIG. 1 and the hardware configuration of the management server 10 illustrated in FIG. 2 is merely an example for achieving the objects of the present disclosure and is not particularly limited. Furthermore, the functional configuration of the management server 10 illustrated in FIG. 3 and the functional configuration of the client terminal 30 illustrated in FIG. 4 are also merely examples and are not particularly limited. It suffices if the information processing system 1 of FIG. 1 is provided with a function with which the above-described processing as a whole can be executed, and which functional configuration is used for realizing this function is not limited to the examples in FIGS. 3 and 4.

The order of steps of the processing executed by the management server 10 illustrated in FIG. 5 and the order of steps of the processing executed by the client terminal 30 illustrated in FIG. 6 are also merely examples and are not particularly limited. The processing is not limited to that executed in a time-series manner according to the order of the illustrated steps. The processing may be executed also in a parallel or individual manner, and thus is not necessarily executed in a time-series manner. Furthermore, the specific examples illustrated in FIGS. 7 to 12B are also merely examples and are not particularly limited.

For example, while each of the plurality of items displayed on the selection screen does not have a hierarchy in the above-described exemplary embodiment, this should not be construed in a limiting sense, and each of the plurality of items may have a hierarchy. In this case, when a plurality of items in a lower layer are displayed in response to selection of each item, the degree of freedom in setting by the user who operates the selection screen may be increased by enabling the user to perform the classification operation, the display setting operation, the order setting operation, and the button display setting operation on the plurality of items in the lower layer.

### APPENDIX

(((1))) An information processing system comprising:
one or more processors configured to:
   receive a classification operation for classifying a plurality of items generated in advance into a displayed item to be displayed on a selection screen and a hidden item not to be displayed;
   display, on the selection screen, the item classified as the displayed item and a button for causing the hidden item to be displayed; and
   display the hidden item on the selection screen when the button is operated.
(((2))) The information processing system according to (((1))), wherein the one or more processors are configured to receive a display setting operation for displaying or hiding the button on the selection screen.
(((3))) The information processing system according to (((2))), wherein the one or more processors are further configured to receive an order setting operation for setting a display order in which each of the displayed and the hidden items is displayed on the selection screen.
(((4))) The information processing system according to (((3))), wherein the one or more processors are not configured to receive the classification operation, the display setting operation, and the order setting operation by a person other than a user or an administrator having a predetermined authority.
(((5))) The information processing system according to (((3))) or (((4))), wherein the one or more processors are configured to display a setting screen configured to receive the classification operation and the order setting operation.
(((6))) The information processing system according to (((5))), wherein the selection screen includes a button for causing the setting screen to be displayed.
(((7))) The information processing system according to (((5))) or (6), wherein the one or more processors are not configured to allow a person other than a user or an administrator having a predetermined authority to access the setting screen.
(((8))) A program causing an information processing apparatus comprising a processor to implement:
a function of receiving a classification operation for classifying a plurality of items generated in advance into a displayed item to be displayed on a selection screen and a hidden item not to be displayed;
a function of displaying on the selection screen, the item classified as the displayed item and a button for causing the hidden item to be displayed; and
a function of displaying the hidden item on the selection screen when the button is operated.

What is claimed is:

1. An information processing system comprising:
one or more processors configured to:
receive a classification operation for classifying a plurality of items generated in advance into a displayed item to be displayed on a selection screen and a hidden item not to be displayed;
display, on the selection screen, the item classified as the displayed item and a button for causing the hidden item to be displayed; and
display the hidden item on the selection screen when the button is operated.

2. The information processing system according to claim 1, wherein the one or more processors are configured to receive a display setting operation for displaying or hiding the button on the selection screen.

3. The information processing system according to claim 2, wherein the one or more processors are further configured to receive an order setting operation for setting a display order in which each of the displayed and the hidden items is displayed on the selection screen.

4. The information processing system according to claim 3, wherein the one or more processors are not configured to receive the classification operation, the display setting operation, and the order setting operation by a person other than a user or an administrator having a predetermined authority.

5. The information processing system according to claim 3, wherein the one or more processors are configured to display a setting screen configured to receive the classification operation and the order setting operation.

6. The information processing system according to claim 5, wherein the selection screen includes a button for causing the setting screen to be displayed.

7. The information processing system according to claim 5, wherein the one or more processors are not configured to allow a person other than a user or an administrator having a predetermined authority to access the setting screen.

8. A non-transitory computer readable medium storing a program causing a processor of an information processing apparatus to execute a process comprising:
receiving a classification operation for classifying a plurality of items generated in advance into a displayed item to be displayed on a selection screen and a hidden item not to be displayed;
displaying on the selection screen, the item classified as the displayed item and a button for causing the hidden item to be displayed; and
displaying the hidden item on the selection screen when the button is operated.
